(19) United States
(12) Patent Application Publication
(10) Pub. No.: US 2012/0088120 A1
(43) Pub. Date: Apr. 12, 2012

(54) METAL-CLAD LAMINATE AND METHOD FOR PRODUCTION OF METAL-CLAD LAMINATE

(75) Inventors: Kimiko Fujisawa, Tokyo (JP); Kenichi Ohga, Tokyo (JP)

(73) Assignee: FURUKAWA ELECTRIC CO., LTD., Tokyo (JP)

(21) Appl. No.: 13/375,918

(22) PCT Filed: Jun. 2, 2010
(86) PCT No.: PCT/JP10/59389

§ 371 Date: Dec. 2, 2011

(30) Foreign Application Priority Data
Jun. 5, 2009 (JP) 2009-135904

(51) Int. Cl. B32B 15/08; B05D 1/36; C23C 28/02; C25D 5/56

(52) U.S. Cl. 428/626; 205/169; 427/97.1

(57) ABSTRACT

Disclosed is a metal-clad laminate and a method for producing a metal-clad laminate wherein adhesion between a metal layer and a thermoplastic film serving as a base material is improved, the deposition rate of a plating coat on the base material is improved, and the insulating resistance after etching is properly adjusted at the same time.

The metal-clad laminate comprises a base material that is composed of a thermoplastic polymer film, a base metal layer that is provided on the surface of the base material, and an upper metal layer that is provided on the surface of the base metal layer.

The base metal layer is made of a copper alloy that contains 0.05-0.21 mass % of phosphorus, and the upper metal layer is made of copper or a copper alloy.

### TECHNICAL FIELD

The present invention relates to a metal-clad laminate and a method for producing a metal-clad laminate.

### BACKGROUND ART

For a flexible circuit substrate, a metal-clad laminate comprised of a polyimide resin film with superior heat resistance on which metal layers (base metal layer/upper metal layer) are formed has been used. The metal of the base metal layer is nickel (Ni) or the like, while the metal of the upper metal layer is copper (Cu) or the like. However, this polyimide resin film has a high water-absorbing property, so there was the problem that the dimensional precision falls in a humid atmosphere. Therefore, attention has been focused on thermoplastic films with superior heat resistance and a low water-absorbing property as a substitute for this polyimide resin film. Among these, a liquid crystal polyester film (liquid crystal polymer) has a high melting point, low permittivity, and superior high-frequency performance, so is suited as a base material of a flexible circuit substrate.

Further, it is known that to form a nickel, copper, or other base metal layer on a thermoplastic film with a low water-absorbing property by electroless plating.

When forming a base metal layer by electroless copper plating, in the past, a plating solution using formaldehyde as a reducing agent has been used, but from the environmental viewpoint and the like, the use of an electroless copper plating solution using hypophosphorous acid as a reducing agent is desirable, so has been studied. However, an electroless copper plating solution using hypophosphorous acid as a reducing agent, unlike the conventional plating solution using formaldehyde as a reducing agent, has the problem that the plating coating does not easily deposit. As a solution to the problem, PLT 1 proposes the method of treating the surface of a film with a palladium-tin mixed catalyst in a pretreatment step of the plating, then immersing the film in a solution including palladium ions so as to enable a copper coating to be easily deposited on the surface of the film and improve the adhesion of the copper coating.

Further, PLT 2 proposes a method for producing a metal-clad laminate comprising providing an electroless nickel-phosphorus alloy layer as a base layer on the surface of a thermoplastic film and improving the adhesion between the thermoplastic film and the base layer.

### CITATION LIST

### Patent Literature

PLT 1: Japanese Patent No. 3325236
PLT 2: Japanese Patent Publication No. 2008-260274

### SUMMARY OF INVENTION

### Technical Problem

However, when using the method described in PLT 1, the amount of palladium deposited on the film increases and a residue of palladium ends up remaining on the surface of the film when etching the copper coating, therefore there is the problem that the insulating resistance is lowered and the practicality becomes poor.

Further, when using the art described in PLT 2, the problem regarding the adhesion strength between the thermoplastic film and the metal layer is solved, however, the problem arises that when etching the copper coating, nickel residue ends up remaining on the surface of the film and the insulating resistance is lowered.

The present invention was made for overcoming the above disadvantages, and has as an object to provide a metal-clad laminate and a method for producing a metal-clad laminate which can simultaneously realize improvement of the adhesion between the thermoplastic film and metal layer and a suitable level of the insulating resistance after etching.

### Means for Overcoming the Disadvanteges

According to the present invention, the following means are provided:

(1) A metal-clad laminate comprising a thermoplastic film, a base metal layer which is provided on a surface of the thermoplastic film, and an upper metal layer which is provided on a surface of the base metal layer, wherein the base metal layer is formed by a copper alloy which contains 0.05 to 0.21 mass % of phosphorus, and the upper metal layer is formed by copper or a copper alloy.
(2) The metal-clad laminate according to (1), wherein the thickness of the base metal layer is 0.05 μm to 0.25 μm.
(3) The metal-clad laminate according to (1) or (2), wherein the film is comprised of a thermoplastic film which can form an optically anisotropic molten phase.
(4) A method of producing a metal-clad laminate comprising: providing a base metal layer comprised of a copper alloy on a surface of a thermoplastic film; and providing an upper metal layer comprised of copper or a copper alloy on a surface of the base metal layer, at treating an electroless copper plating for forming the base metal layer, dipping the laminate in an oxidizing agent after a catalyst activation process, and performing the electroless copper plating.
(5) The method of producing a metal-clad laminate according to (4), wherein the upper metal layer is formed by electrolytic plating.

### Advantageous Effects of Invention

According to the present invention, it is possible to simultaneously realize improvement of the adhesion between the thermoplastic film and metal layer and a suitable level of the insulating resistance after etching.

### DESCRIPTION OF EMBODIMENTS

Embodiments of the present invention will be explained next. Note that the embodiments explained below are for explanatory use and do not limit the scope of the present invention. Therefore, persons skilled in the art can employ embodiments in which the individual elements or all the elements are replaced with equivalents. These embodiments are also included in the scope of the present invention.

A metal-clad laminate according to one embodiment of the present invention is provided with a film, a base metal layer, and an upper metal layer. The film is suitably selected, according to the application of the metal-clad laminate to be prepared, from a flexible film, a rigid film, or the like. In the embodiment, a thermoplastic film, in particular a film which has a low hygroscopicity and is able to withstand the heat treatment temperature in later explained process is preferably selected.

As the low hygroscopic film to be able to withstand the heat treatment temperature in the later explained process, a thermoplastic polyimide film, a thermoplastic polyester film (among thermoplastic polyester films, polyethylene naphthalate (PEN) is better than polyethylene terephthalate (PET) because the heat resistance is higher), or the like may be selected.

Further, a thermoplastic polymer which is able to form an optically anisotropic molten phase, what is called a “thermoplastic liquid crystal polymer”, has a resistant temperature of a high approximately 300° C. and can sufficiently withstand heat treatment. Also, polyether ether ketone (PEEK) is preferable as a thermoplastic resin to be able to withstand heat treatment. The above-mentioned films all have low water-absorbing properties, so are suitable for wet type plating.

Further, the film forming part of the metal-clad laminate can be roughened at its surface so as to better improve the adhesion between the film and the metal layer.

Here, as the method for roughening the surface of the film, for example, the method of dipping the film in an etching solution is easy and therefore preferable. For the etching solution used for etching the surface of the film, a strong alkaline solution, a permanganate solution, a chromate solution, or the like may be used. For example, in the case of a liquid crystal polymer film, it is effective to use a strong alkaline solution. Further, for a film which is difficult to etch, sandblasting or another mechanical polishing method is effective.

The base metal layer is formed on the film at its front surface. This state is sometimes called the “first laminate”. In the present embodiment, the base metal layer is made of a copper alloy that contains 0.05 to 0.21 mass % of phosphorus (copper-phosphorus alloy). By the base metal layer containing 0.05 to 0.21 mass % of phosphorus (preferably 0.07 to 0.16 mass %), the adhesion between the film and the metal layer is improved. If the phosphorus is less than 0.05 mass %, the adhesion between the film and the metal layer is not improved, so this is undesirable. Further, if the phosphorus is over 0.21 mass %, the deposition rate of the coating is low, so this is industrially undesirable. Note that the base metal layer may be one plating layer or two or more plating layers. If considering the production process, it is preferred to make two layers the upper limit.

The upper metal layer is formed on the front surface of the first laminate. This state is sometimes called the “second laminate”. In this embodiment, the upper metal layer is made of copper or a copper alloy. When the upper metal layer is made of a copper alloy, it can be made of the same composition as the copper alloy of the base metal layer or a different one. Since the base metal layer of the first laminate is a copper alloy layer, there are the advantages that the electric conductivity of the base metal layer is high and it is easy to form the upper metal layer by electrolytic plating or the like when forming the second laminate. When forming the upper metal layer by electrolytic plating, the thickness of the base metal layer is preferably 0.05 to 0.25 μm.

When the thickness of the base metal layer is less than 0.05 μm, the adhesion between the film and the metal layer is poor and, further, the sheet resistance is high and formation of the upper metal layer becomes difficult, so this is undesirable. Further, the thickness of the plating is made not more than 0.25 μm because with electroless plating, formation of the base metal layer requires time, so formation of a greater thickness is industrially undesirable. Further, the role as a base metal layer is judged sufficient at 0.25 μm thickness or less. Note that the formation of the base metal layer will be explained later.

The metal-clad laminate of this embodiment of the present invention is produced as follows. First, at the necessary locations on the surface of the film, electroless plating is used to form a base metal layer comprised of a copper alloy including phosphorus (formation of first laminate). Electroless plating is employed because it can form a metal layer on a film more easily than dry processing or the like.

In this embodiment, hypophosphorous acid is added to the electroless plating solution. Hypophosphorous acid is a reducing agent. In the electroless copper plating coating which is formed as the base metal layer, a slight amount of phosphorus coprecipitates due to the decomposition of the hypophosphorous acid. Still more, regarding hypophosphorous acid, a catalytic activity to copper is extremely low. If the palladium of the catalyst which is provided on the surface of the film ends up being covered by a copper coating at the time of plating, the activity will drop and the deposition of copper will cease at a plating thickness of about 0.25 μm. Thus, formation of a plating thickness of 0.25 μm or more is difficult and is industrially undesirable if considering formation of a copper layer by electrolytic plating in the next step.

Next, the thus formed first laminate is heat treated. Due to this, the adhesion between the film and the base metal layer is improved. The heat treatment conditions are heating in a nonoxidizing atmosphere at a temperature lower than a melting point of the film (Tm) by about 35 to 85 degrees Centigrade for 2 to 60 minutes. If the heat treatment temperature is low, it is desirable to heat for long time, while if the heat treatment temperature is high, it is desirable to heat for a short time. Here, the “temperature lower than a melting point of the film (Tm) by about 35 to 85 degrees Centigrade” is about 200° C. to 280° C. in the case of a thermoplastic polyester film and is about 310° C. and 360° C. in the case of a thermoplastic polyimide film.

The above-mentioned heat treatment method may, for example, be performed using a hot-air drying furnace, an infrared heater furnace, a heated metal roll, or the like. Further, the heat treatment may be performed as a batch type with mounting onto a metal mesh or the like or may be performed by conveying continuously the film in a roll state.

Next, the surface of the first laminate is plated to form an upper metal layer comprised of copper or a copper alloy (formation of second laminate). The upper metal layer is formed by electrolytic plating. Since the base metal layer is a copper alloy, it is easy to improve the coating deposition rate at the time of plating by electrolytic plating.

Considering conductivity and the like, the thickness of the upper metal layer is, in combination with the thickness of the base metal layer, 2 to 20 μm. Note that the upper metal layer may be one plating layer or two or more plating layers.

In the metal-clad laminate according to the present invention, through-holes for conduction use which connect the front and back surfaces of the film in the thickness direction of the film may be formed.

As the method for forming the through-holes, it is possible to use lasering, drilling, etching using a strong alkaline solution, etc.

As the method of obtaining the metal-clad laminate in which through-holes for conduction use are formed, (1) first, through-holes are formed in the metal-clad laminate film. (2) Next, an electroless plating layer is formed. (3) Next, electroplating is used to form the upper metal layer.

As another method, (1) first, through-holes are formed at the surface of the film in advance. (2) Next, the base layer is formed on the surface of the film and on the inside walls of the through-holes. (3) Next, heat treatment, then plating is used to form the upper metal layer to thereby form the metal-clad laminate.

In this case, the adhesion between the conductors in the through-holes and the film is improved.

Note that in conventional formation of through-holes in a metal-clad laminate, (1) first, through-holes are formed in the metal-clad laminate. (2) Next, an electroless plating layer is formed at the conductor layer and the through-hole parts as a whole. (3) Next, electroplating or the like is used to form the upper metal layer. For this reason, the conductor layer ends up having a certain thickness or more. However, by forming the conductor layer and the metal layer of the through-hole parts together as explained above, the conductor layer can be formed thinly.

The above explained metal-clad laminate can be used a one-sided flexible substrate by forming the metal layer on just one surface of the film or can be used as a two-sided flexible substrate by forming the metal layer on both surfaces of the film. Further, it is possible to stack a plurality of laminates formed with metal layers at only first surfaces thereof and use the result as a multilayer board.

Next, several preferred examples of the present invention will be described.

### EXAMPLES

A thermoplastic film was roughened and catalyzed, then was successively electrolessly plated with copper, heat treated, and electrolytically plated with copper to produce a metal-clad laminate. The obtained metal-clad laminate was evaluated for peeling strength and coating deposition rate at the time of plating. Note that the electroless plating layer and the electrolytic plating layer were formed on both surfaces of the film.

### Example 1

As the thermoplastic film in Example 1 (Invention Examples 1 to 7), a liquid crystal polymer film (Vecster Conn. produced by KURARAY Co., Ltd., thickness of 50 μm) was used. The film was cut into 240 mm×300 mm pieces. These were dipped in a 10N potassium hydroxide solution (solution temperature of 80° C.) for 10 minutes for roughening the film.

Note that in general a thermoplastic polymer film differs in surface relief at the two sides of the film in the state before roughening. The surface with the smaller surface relief is referred to as the “shine surface (S-surface)”, while the surface with the larger surface relief is referred to as the “matte surface (M-surface)”. The peeling strength was evaluated by measuring both the S-surface and the M-surface.

The catalyzation is performed by washing the base material surface with a conditioner (treatment solution 1: temperature of about 55° C. for 1 minute).

After this, pre-dip treatment (treatment solution 2: temperature of about 20° C. for 30 seconds) is performed.

Next, Catalyst C-10 (palladium/tin colloid catalyst solution, temperature of 30° C. for 1 minute) made by Okuno Chemical Industries Co., Ltd. was used to impart the catalyst.

Next, an accelerator (treatment solution 3: temperature of about 20° C. for 1 minute) was used to activate the catalyst.

Then, the material was dipped in an oxidizing agent (treatment solution 4: temperature of about 50° C. for 1 minute), the tin which remained at the time of treatment by the palladium/tin colloid catalyst solution was oxidized, and a copper coating was made easier to deposit. The material was rinsed and dried at each step.

(Composition of Treatment Solution)

### Treatment Solution 1

2-aminoethanol: 5 milliliter/liter

Triethanolamine: 0.3 milliliter/liter

Dimethylamine-based surfactant: 0.5 milliliter/liter

Polyalkoxylate alcohol-based surface-active agent: 0.6 milliliter/liter

### Treatment Solution 2

Hydrochloric acid: 200 milliliter/liter

### Treatment Solution 3

Hydrochloric acid: 50 milliliter/liter

### Treatment Solution 4

Sodium chlorite: 3 gram/liter

For the electroless plating of copper for forming the base metal layer, the following plating bath composition and plating conditions were used so as to form an electroless copper plating layer of 0.1 μm thickness. At the electroless copper plating coating foamed as the base metal layer, a slight amount of phosphorus is coprecipitated by the decomposition of the reducing agent hypophosphorous acid. The phosphorus concentration in the base metal layer was changed between 0.05 mass % (Invention Example 1) and 0.21 mass % (Invention Example 7) by adjusting the pH. The higher the pH of the plating bath, the lower the deposition rate of the coating and the higher the phosphorus concentration in the coating. Further, the lower the pH, the higher the deposition rate of the coating and the lower the phosphorus concentration in the coating. The pH of the plating bath was adjusted to 7.2 to 9.6 using dilute sulfuric acid and a sodium hydroxide aqueous solution and adjusting the temperature to 70° C. to 80° C. The phosphorus concentration in the base metal layer was measured by dissolving the base metal layer in a nitric acid solution, then using an inductively-coupled plasma atomic emission spectroscopy device (produced by Shimadzu Corporation, ICPS-7500) for mass spectroscopy. The thickness of the base metal layer was measured using an X-ray fluorescence thickness meter (produced by Seiko Instruments Inc., SFT3200).

Further, even after the upper metal layer was formed and the copper-clad laminate was produced, the thickness of the base metal layer can be estimated.

The thickness of the base metal layer after producing the copper-clad laminate is estimated by the following technique. (1) The film is dissolved in a strong alkaline solution to obtain a state of a foil-like metal layer comprised of the upper metal layer and the base metal layer combined. (2) Secondary ion mass spectrometry (SIMS) is used to analyze this in the depth direction until phosphorus is no longer detected from the base metal layer side of the foil-like metal layer (side of interface with the film).

Regarding the secondary ion mass spectrometry, in more detail, sputtering is performed from the dissolved film side by a constant rate and the phosphorus and copper were detected. The sputtering is performed until passing through the metal layer. The base metal layer is identified by defining the area having over half of the peak intensity from the baseline of the phosphorus detected as the electroless copper plating layer including phosphorus (base metal layer). Further, the difference of the sputter rate between the base metal layer and the upper metal layer is believed to be based on the difference of the structures of the two. For example, when the base metal layer is an electroless plating layer and the upper metal layer is an electrolytic plating layer, by experience, by making the sputter rate of the base metal layer twice the sputter rate of the upper metal layer, the thickness of the base layer can be obtained accurately.

For example, the thickness of the base layer in a copper-clad laminate comprised of a base electroless plating layer of 0.1 μm thickness on which an electrolytic copper plating layer of 10 μm thickness was formed was measured by the above technique. The results are shown below:

(Measurement Conditions)

Primary ions: Cs+

Secondary (detection) ions: 31P−, 63Cu−, 18O−

Sputter area: 200 μm×400 μm

First, the thickness of the metal layer (base metal layer+upper metal layer) measured by an X-ray fluorescence thickness meter was 10.1 μm. Further, from the results of secondary ion mass spectrometry, the sputter time of the base metal layer was 0.5% (=0.005 time) of the time for all of the metal layer to pass. In addition, the sputter rate of the base metal layer was twice the sputter rate of the upper metal layer. The thickness of the base metal layer could be calculated to be 0.1 μm (10.1 (μm)×0.005×2). This value matched the thickness measured by X-ray fluorescence immediately after base plating.

The conditions for forming the base metal layer and the upper metal layer will be explained below.

(Composition of Electroless Copper Plating Bath)

Copper sulfate 5-hydrate (as copper component): 19 gram/liter

HEEDTA (chelating agent): 50 gram/liter

Sodium phosphinate (reducing agent): 30 gram/liter

Sodium chloride: 20 gram/liter

Disodium hydrogenphosphate: 15 gram/liter

(Plating Conditions)

Bath temperature: 75° C.

pH: 7.2 to 9.6

Plating time: 4 minutes

To improve the adhesion between the film and the base metal layer, after forming the base metal layer, a heat treatment process was performed in a nitrogen atmosphere at 240° C. for 10 minutes.

Then, a copper sulfate bath was used for copper electrolytic plating to form the upper metal layer so that the total thickness of the base metal layer and the upper metal layer (thickness of conductor) became 8 μm. The plating bath composition is described below. Note that as an additive, Cu-Brite TH-RIII produced by Ebara-Udylite Co., Ltd. was used.

(Composition of Electrolytic Copper Plating Bath)

Copper sulfate: 120 gram/liter

Sulfuric acid: 100 gram/liter

Hydrochloric acid: 0.125 gram/liter (as chlorine ions)

(Plating Conditions)

Current density: 4.5 A/dm²

Each of the obtained metal-clad laminates as measured for adhesion (peeling strength) and evaluated for deposition rate of the electroless copper plating coating. The results are shown in Table 1. In the evaluation results, “V. good” means excellent, “Good” means good, “Fair” means acceptable, and “Poor” means unacceptable.

(Adhesion (Peeling Strength))

The adhesion was evaluated by measuring both of the S-surface and M-surface of the film for peel off strength (peel strength) of the metal layer based on a mechanical performance test described in JIS C5016 (90 degree direction peel off method). A value of 0.28 kN/m or more was judged as “good”, while one of less was judged as “poor”. Further, in Table 1, the results are shown as follows in accordance with the measured values.

0.32 kN/m or more: “V. good”

Less than 0.32 kN/m to 0.3 kN/m: “Good”

Less than 0.3 kN/m to 0.28 kN/m: “Fair”

Less than 0.28 kN/m: “Poor”

(Deposition Rate of Base Plating Coating)

A deposition rate of the base plating coating of 0.03 μm/min or more was judged as “good”, while one of less was judged as “poor””.

Further, in Table 1, the results are shown as follows in accordance with the measured values.

0.05 μm/min or more: “V. good”

Less than 0.05 μm/min to 0.03 μm/minute: “Good”

Less than 0.03 μm/min: “Poor”

(Comprehensive Evaluation)

The evaluation results were considered for a comprehensive evaluation.

In Table 1, the results are shown as follows in accordance with the evaluation results.

Particularly excellent: “V. good”

Excellent: “Good”

Unacceptable: “Poor”

### COMPARATIVE EXAMPLES

Next, liquid crystal polymer film which was roughened in the same way as with Example 1 was catalyzed. The catalyzation was performed using treatment solutions and conditions described in Example 1 for conditioning, pre-dipping, catalyzation by Catalyst, and catalyst activation by an accelerator and, further, dipping in an oxidizing agent after catalyst activation. Further, the material was rinsed and dried at each process. Next, electroless copper plating treatment was performed by adjusting the pH of the plating bath to less than pH 7.2 or to pH 9.7 or more so as to prepare samples in which the phosphorus concentration was less than 0.05 mass % or over 0.21 mass %. Then, the steps of the electrolytic plating treatment were successively performed to produce metal-clad laminates. That is, the steps of heat treatment and electrolytic plating treatment were successively performed to produce metal-clad laminates. In other words, except for the treatment condition (pH) of the electroless copper plating, all pre-treatment steps were performed in the same way as with Example 1.

TABLE 1

| | Base | Plating conditions | | | | | | | | | |
|---|---|---|---|---|---|---|---|---|---|---|---|
| | mate- | | | Phosphorus | | Properties | | | | | |
| | rial | Temp. | | concentration | Thickness | Peeling strength (kN/m) | | | | Deposition | Comprehensive |
| No. | film | (° C.) | pH | (mass %) | (μm) | S-surface | | M-surface | | rate | evaluation |
| Inv. Ex. 1 | LCP | 75 | 7.2 | 0.05 | 0.10 | 0.308 | Good | 0.309 | Good | V. good | Good |
| Inv. Ex. 2 | | 75 | 7.4 | 0.06 | 0.10 | 0.313 | Good | 0.312 | Good | V. good | Good |
| Inv. Ex. 3 | | 75 | 7.7 | 0.07 | 0.10 | 0.324 | V. good | 0.326 | V. good | V. good | Good |
| Inv. Ex. 4 | | 75 | 8.4 | 0.13 | 0.10 | 0.343 | V. good | 0.345 | V. good | V. good | V. good |
| Inv. Ex. 5 | | 75 | 8.8 | 0.16 | 0.10 | 0.359 | V. good | 0.357 | V. good | V. good | V. good |
| Inv. Ex. 6 | | 75 | 9.2 | 0.17 | 0.10 | 0.368 | V. good | 0.365 | V. good | Good | V. good |
| Inv. Ex. 7 | | 75 | 9.6 | 0.21 | 0.10 | 0.377 | V. good | 0.379 | V. good | Good | V. good |
| Comp. Ex. 1 | | 75 | 6.8 | 0.03 | 0.10 | 0.263 | Poor | 0.261 | Poor | Good | Poor |
| Comp. Ex. 2 | | 75 | 7.0 | 0.04 | 0.10 | 0.279 | Poor | 0.278 | Poor | Good | Poor |
| Comp. Ex. 3 | | 75 | 9.7 | 0.22 | 0.10 | 0.395 | V. good | 0.398 | V. good | Poor | Poor |
| Comp. Ex. 4 | | 75 | 9.8 | 0.23 | 0.10 | 0.409 | V. good | 0.402 | V. good | Poor | Poor |

As is evident from Table 1, the samples which were prepared in Example 1 (Invention Examples 1 to 7) of the present invention and which had phosphorus concentrations in the electroless copper plating layers of 0.05 mass % to 0.21 mass % all had peeling strengths of 0.3 kN/m or more, that is, were excellent in adhesion. Additionally, the deposition rates of the coatings were also excellent 0.03 μm/min values or more.

On the other hand, the samples which are shown as comparative examples (Comparative Example 1 to 4) and which had phosphorus concentrations in the electroless copper plating layers of 0.05 mass % and less had peeling strengths of less than 0.3 kN/m, that is, poor adhesion. Further, the samples which had phosphorus concentrations in the electroless copper plating layer of 0.21 mass % or more had coating deposition rates at the time of forming the base layers of less than 0.03 μm/min, that is, slow rates, so are undesirable, it was learned.

### Example 2

As Example 2 (Invention Examples 8 to 28), the effect of the thickness of the base metal layer on the adhesion with the resin was evaluated. The samples were prepared in the same way as in Example 1 by roughening of the film surface, then conditioning, pre-dipping, catalyzation by Catalyst, catalyst activation using an accelerator, and dipping in an oxidizing agent after catalyst activation. Then, electrolytic copper plating was used to form an 8 μm thick metal layer. The thickness of the base metal layer was adjusted by adjusting the treatment time of the electroless copper plating within 1 to 8 minutes to thereby prepare a metal-clad laminate having a thickness of the base metal layer of 0.05 μm to 0.25 μm.

The various metal-clad laminates which had different thicknesses of the base layers were evaluated for adhesion and the deposition rate at the time of forming the base metal layer. The evaluation results were considered for the comprehensive evaluation.

In Table 2 as well, in the same way as with Table 1, the findings are expressed “V. good”, “Good”, “Fair”, and “Poor” in accordance with the evaluation results.

TABLE 2

| | | Plating conditions | | | | | | | | | |
|---|---|---|---|---|---|---|---|---|---|---|---|
| | Base | | | Phosphorus | | | | | | | |
| | mate- | | | concen- | | Properties | | | | Deposi- | Comprehen- |
| | rial | Temp. | | tration | Thickness | Peeling strength (kN/m) | | | | tion | sive |
| No. | film | (° C.) | pH | (mass %) | (μm) | S-surface | | M-surface | | rate | evaluation |
| Inv. Ex. 8 | LCP | 75 | 7.2 | 0.05 | 0.05 | 0.302 | Good | 0.301 | Good | V. good | Good |
| Inv. Ex. 9 | | 75 | 7.2 | 0.05 | 0.09 | 0.308 | Good | 0.307 | Good | V. good | Good |
| Inv. Ex. 10 | | 75 | 7.2 | 0.05 | 0.15 | 0.323 | V. good | 0.321 | V. good | V. good | Good |
| Inv. Ex. 11 | | 75 | 7.2 | 0.05 | 0.20 | 0.343 | V. good | 0.342 | V. good | V. good | V. good |
| Inv. Ex. 12 | | 75 | 7.2 | 0.05 | 0.25 | 0.355 | V. good | 0.356 | V. good | V. good | V. good |
| Inv. Ex. 13 | | 75 | 8.5 | 0.12 | 0.05 | 0.318 | Good | 0.316 | Good | V. good | Good |
| Inv. Ex. 14 | | 75 | 8.5 | 0.12 | 0.09 | 0.343 | V. good | 0.342 | V. good | V. good | V. good |
| Inv. Ex. 15 | | 75 | 8.5 | 0.12 | 0.15 | 0.355 | V. good | 0.358 | V. good | V. good | V. good |
| Inv. Ex. 16 | | 75 | 8.5 | 0.12 | 0.20 | 0.367 | V. good | 0.369 | V. good | V. good | V. good |
| Inv. Ex. 17 | | 75 | 8.5 | 0.12 | 0.25 | 0.379 | V. good | 0.378 | V. good | V. good | V. good |
| Inv. Ex. 18 | | 75 | 9.5 | 0.20 | 0.05 | 0.335 | V. good | 0.338 | V. good | Good | Good |
| Inv. Ex. 19 | | 75 | 9.5 | 0.20 | 0.09 | 0.374 | V. good | 0.373 | V. good | Good | Good |
| Inv. Ex. 20 | | 75 | 9.5 | 0.20 | 0.15 | 0.389 | V. good | 0.388 | V. good | Good | Good |
| Inv. Ex. 21 | | 75 | 9.5 | 0.20 | 0.20 | 0.403 | V. good | 0.404 | V. good | Good | Good |
| Inv. Ex. 22 | | 75 | 9.5 | 0.20 | 0.25 | 0.412 | V. good | 0.413 | V. good | Good | Good |
| Inv. Ex. 23 | | 75 | 7.2 | 0.05 | 0.03 | 0.281 | Fair | 0.280 | Fair | V. good | Fair |
| Inv. Ex. 24 | | 75 | 7.2 | 0.05 | 0.04 | 0.285 | Fair | 0.286 | Fair | V. good | Fair |
| Inv. Ex. 25 | | 75 | 8.5 | 0.12 | 0.03 | 0.285 | Fair | 0.286 | Fair | V. good | Fair |
| Inv. Ex. 26 | | 75 | 8.5 | 0.12 | 0.04 | 0.294 | Fair | 0.293 | Fair | V. good | Fair |
| Inv. Ex. 27 | | 75 | 9.5 | 0.20 | 0.03 | 0.287 | Fair | 0.288 | Fair | Good | Fair |
| Inv. Ex. 28 | | 75 | 9.5 | 0.20 | 0.04 | 0.298 | Fair | 0.297 | Fair | Good | Fair |

As is evident from Table 2, regarding the adhesion strength, when the thickness of the base layer was 0.05 μm or more, the peeling strength was 0.3 kN/m or more or very favorable. Further, in this case, the deposition rate of the base coating was 0.03 μm/min or more, that is, favorable. Further, when the phosphorus concentration in the base layer was 0.05% to 0.21% and the base layer was less than 0.05 μm as shown in Invention Examples 23 to 28, the peeling strength was 0.28 kN/m or more or a favorable adhesion strength for practical use. However, in this case, the conductivity in the later step of electrolytic plating was a little low, so the evaluation thereof was “Fair”.

### Example 3

As Example 3 (Invention Examples 29 to 100), the adhesion between the film and the base metal layer in the metal-clad laminate and the coating deposition rate of the plating when using different base material films were evaluated. The various films were roughened, then were treated in the same way as with Example 1 for catalyzation, electroless copper plating (pH:7.2 to 9.6, bath temperature: 75° C.), heat treatment, an electrolytic copper plating to 8 μm thickness in that order so as to produce a metal-clad laminate.

For the film in the metal-clad laminate, polyethylene terephthalate (PET), polyimide (PI), polyetheretherketone (PEEK), and polyethylene naphthalate (PEN) were used.

For the PET, Tetron HSL (50 μm) produced by Teijin DuPont Film Japan Ltd. was used. In the roughening of the film, surface relief was formed on the surface by sandblasting.

For PEEK, IBUKI (50 μm) produced by Mitsubishi Plastics Inc. was used. In the roughening of the film, surface relief was formed on the surface by dipping the film in a 10N potassium hydroxide solution at 80° C. for 10 minutes to dissolve the surface.

For PI, the thermoplastic polyimide AURAM (25 μm) produced by Mitsui Chemicals, Inc. was used. In the roughening of the film, surface relief was formed on the surface by dipping the film in a 10N potassium hydroxide solution at 80° C. for 10 minutes to dissolve the surface.

For PEN, TEONEX Q83 (50 μm) produced by Teijin DuPont Film Japan Limited was used. In the roughening of the film, surface relief was formed on the surface by sandblasting.

The heat treatment was performed at the heat treatment temperature described in Table 3 for 10 minutes in a nitrogen atmosphere.

Each of the obtained metal-clad laminates was evaluated for adhesion and deposition rate in the same way as in Example 1. The results were considered for the comprehensive evaluation. The results are shown in Table 3 to Table 6.

In Table 3 to Table 6, as with Table 1 etc., “V. good”, “Good”, “Fair”, and “Poor” are shown in accordance with the evaluation results.

Examples of PET, PI, PEEK, and PEN as film are given as Invention Examples 29 to 46, Invention Examples 47 to 64, Invention Examples 65 to 82, and Invention Examples 83 to 100, respectively.

As is evident from Table 3, when the phosphorus concentration was 0.05 mass % to 0.21 mass %, the adhesion strength between the film and the base metal layer was in all cases a peeling strength of 0.28 kN/m or more, that is, the adhesion was good. Additionally, the deposition rate was 0.03 μm/min or more or good.

These results showed that even in a case of using a thermoplastic resin other than LCP, when the phosphorus concentration in the base metal layer was 0.05 mass % to 0.21 mass %, the adhesion between the resin and the metal layer was excellent and the formation rate of the base layer was good.

TABLE 3

| | | Plating conditions | | | | | | | |
|---|---|---|---|---|---|---|---|---|---|
| | Base | | | Phosphorus | Thick- | Properties | | | |
| | material | Temp. | | concentration | ness | Peeling strength | | Deposition | Comprehensive |
| No. | film | (° C.) | pH | (mass %) | (μm) | (kN/m) | | rate | evaluation |
| Inv. Ex. 29 | PET | 75 | 7.2 | 0.05 | 0.10 | 0.304 | Good | V. good | Good |
| Inv. Ex. 30 | (Tm | 75 | 7.7 | 0.07 | 0.10 | 0.310 | Good | V. good | Good |
| Inv. Ex. 31 | 256° C.) | 75 | 8.4 | 0.12 | 0.10 | 0.315 | Good | V. good | Good |
| Inv. Ex. 32 | Heat | 75 | 9.0 | 0.16 | 0.10 | 0.321 | V. good | Good | V. good |
| Inv. Ex. 33 | treatment | 75 | 9.2 | 0.17 | 0.10 | 0.327 | V. good | Good | Good |
| Inv. Ex. 34 | (210° C.) | 75 | 9.6 | 0.21 | 0.11 | 0.335 | V. good | Good | Good |
| Inv. Ex. 35 | | 75 | 7.2 | 0.05 | 0.04 | 0.285 | Fair | V. good | Fair |
| Inv. Ex. 36 | | 75 | 7.2 | 0.05 | 0.05 | 0.301 | Good | V. good | Good |
| Inv. Ex. 37 | | 75 | 7.2 | 0.05 | 0.15 | 0.309 | Good | V. good | Good |
| Inv. Ex. 38 | | 75 | 7.2 | 0.05 | 0.25 | 0.321 | V. good | V. good | V. good |
| Inv. Ex. 39 | | 75 | 8.5 | 0.12 | 0.04 | 0.292 | Fair | V. good | Fair |
| Inv. Ex. 40 | | 75 | 8.5 | 0.12 | 0.05 | 0.306 | Good | V. good | Good |
| Inv. Ex. 41 | | 75 | 8.5 | 0.12 | 0.15 | 0.319 | Good | V. good | Good |
| Inv. Ex. 42 | | 75 | 8.5 | 0.12 | 0.25 | 0.329 | V. good | V. good | V. good |
| Inv. Ex. 43 | | 75 | 9.5 | 0.20 | 0.04 | 0.298 | Fair | Good | Fair |
| Inv. Ex. 44 | | 75 | 9.5 | 0.20 | 0.05 | 0.319 | Good | Good | Good |
| Inv. Ex. 45 | | 75 | 9.5 | 0.20 | 0.15 | 0.347 | V. good | Good | Good |
| Inv. Ex. 46 | | 75 | 9.5 | 0.20 | 0.25 | 0.356 | V. good | Good | Good |

TABLE 4

| | | Plating conditions | | | | | | | |
|---|---|---|---|---|---|---|---|---|---|
| | | | | Phosphorus | | | | | |
| | Base | | | concen- | Thick- | Properties | | | |
| | material | Temp. | | tration | ness | Peeling strength | | Deposition | Comprehensive |
| No. | film | (° C.) | PH | (mass %) | (μm) | (kN/m) | | rate | evaluation |
| Inv. Ex. 47 | PI | 75 | 7.2 | 0.05 | 0.10 | 0.306 | Good | V. good | Good |
| Inv. Ex. 48 | (Tm | 75 | 7.7 | 0.07 | 0.10 | 0.313 | Good | V. good | Good |
| Inv. Ex. 49 | 388° C.) | 75 | 8.4 | 0.12 | 0.10 | 0.319 | Good | V. good | Good |
| Inv. Ex. 50 | Heat | 75 | 9.0 | 0.16 | 0.10 | 0.325 | V. good | Good | Good |
| Inv. Ex. 51 | treatment | 75 | 9.2 | 0.17 | 0.10 | 0.332 | V. good | Good | Good |
| Inv. Ex. 52 | (350° C.) | 75 | 9.6 | 0.21 | 0.11 | 0.339 | V. good | Good | Good |
| Inv. Ex. 53 | | 75 | 7.2 | 0.05 | 0.04 | 0.286 | Fair | V. good | Fair |
| Inv. Ex. 54 | | 75 | 7.2 | 0.05 | 0.05 | 0.302 | Good | V. good | Good |
| Inv. Ex. 55 | | 75 | 7.2 | 0.05 | 0.15 | 0.311 | Good | V. good | Good |
| Inv. Ex. 56 | | 75 | 7.2 | 0.05 | 0.25 | 0.319 | Good | V. good | Good |
| Inv. Ex. 57 | | 75 | 8.5 | 0.12 | 0.04 | 0.291 | Fair | V. good | Fair |
| Inv. Ex. 58 | | 75 | 8.5 | 0.12 | 0.05 | 0.305 | Good | V. good | Good |
| Inv. Ex. 59 | | 75 | 8.5 | 0.12 | 0.15 | 0.326 | V. good | V. good | V. good |
| Inv. Ex. 60 | | 75 | 8.5 | 0.12 | 0.25 | 0.333 | V. good | V. good | V. good |
| Inv. Ex. 61 | | 75 | 9.5 | 0.20 | 0.04 | 0.297 | Fair | Good | Fair |
| Inv. Ex. 62 | | 75 | 9.5 | 0.20 | 0.05 | 0.309 | Good | Good | Good |
| Inv. Ex. 63 | | 75 | 9.5 | 0.20 | 0.15 | 0.349 | V. good | Good | Good |
| Inv. Ex. 64 | | 75 | 9.5 | 0.20 | 0.25 | 0.361 | V. good | Good | Good |

TABLE 5

| | | Plating conditions | | | | | | | |
|---|---|---|---|---|---|---|---|---|---|
| | | | | Phosphorus | | | | | |
| | Base | | | concen- | Thick- | Properties | | | |
| | material | Temp. | | tration | ness | Peeling strength | | Deposition | Comprehensive |
| No. | film | (° C.) | PH | (mass %) | (μm) | (kN/m) | | rate | evaluation |
| Inv. Ex. 65 | PEEK | 75 | 7.2 | 0.05 | 0.10 | 0.309 | Good | V. good | Good |
| Inv. Ex. 66 | (Tm | 75 | 7.7 | 0.07 | 0.11 | 0.313 | Good | V. good | Good |
| Inv. Ex. 67 | 335° C.) | 75 | 8.4 | 0.12 | 0.10 | 0.325 | V. good | V. good | V. good |
| Inv. Ex. 68 | Heat | 75 | 8.8 | 0.16 | 0.11 | 0.332 | V. good | V. good | V. good |
| Inv. Ex. 69 | treatment | 75 | 9.2 | 0.17 | 0.11 | 0.341 | V. good | Good | Good |
| Inv. Ex. 70 | (300° C.) | 75 | 9.6 | 0.21 | 0.11 | 0.345 | V. good | Good | Good |
| Inv. Ex. 71 | | 75 | 7.2 | 0.05 | 0.04 | 0.287 | Fair | V. good | Fair |
| Inv. Ex. 72 | | 75 | 7.2 | 0.05 | 0.05 | 0.301 | Good | V. good | Good |
| Inv. Ex. 73 | | 75 | 7.2 | 0.05 | 0.15 | 0.313 | Good | V. good | Good |
| Inv. Ex. 74 | | 75 | 7.2 | 0.05 | 0.25 | 0.324 | V. good | V. good | V. good |
| Inv. Ex. 75 | | 75 | 8.5 | 0.12 | 0.04 | 0.292 | Fair | V. good | Fair |
| Inv. Ex. 76 | | 75 | 8.5 | 0.12 | 0.05 | 0.309 | Good | V. good | Good |
| Inv. Ex. 77 | | 75 | 8.5 | 0.12 | 0.15 | 0.332 | V. good | V. good | V. good |
| Inv. Ex. 78 | | 75 | 8.5 | 0.12 | 0.25 | 0.340 | V. good | V. good | V. good |
| Inv. Ex. 79 | | 75 | 9.5 | 0.20 | 0.04 | 0.299 | Fair | Good | Fair |
| Inv. Ex. 80 | | 75 | 9.5 | 0.20 | 0.05 | 0.321 | V. good | Good | Good |
| Inv. Ex. 81 | | 75 | 9.5 | 0.20 | 0.15 | 0.353 | V. good | Good | Good |
| Inv. Ex. 82 | | 75 | 9.5 | 0.20 | 0.25 | 0.362 | V. good | Good | Good |

TABLE 6

| | | Plating conditions | | | | | | | |
|---|---|---|---|---|---|---|---|---|---|
| | | | | Phosphorus | | | | | |
| | Base | | | concen- | Thick- | Properties | | | |
| | material | Temp. | | tration | ness | Peeling strength | | Deposition | Comprehensive |
| No. | film | (° C.) | pH | (mass %) | (μm) | (kN/m) | | rate | evaluation |
| Inv. Ex. 83 | PEN | 75 | 7.2 | 0.05 | 0.10 | 0.309 | Good | V. good | Good |
| Inv. Ex. 84 | (Tm | 75 | 7.7 | 0.07 | 0.11 | 0.312 | Good | V. good | Good |
| Inv. Ex. 85 | 272° C.) | 75 | 8.4 | 0.12 | 0.10 | 0.316 | Good | V. good | Good |
| Inv. Ex. 86 | Heat | 75 | 8.8 | 0.16 | 0.10 | 0.322 | V. good | V. good | V. good |
| Inv. Ex. 87 | treatment | 75 | 9.2 | 0.17 | 0.10 | 0.325 | V. good | Good | Good |
| Inv. Ex. 88 | (240° C.) | 75 | 9.6 | 0.21 | 0.10 | 0.333 | V. good | Good | Good |
| Inv. Ex. 89 | | 75 | 7.2 | 0.05 | 0.04 | 0.283 | Fair | V. good | Fair |
| Inv. Ex. 90 | | 75 | 7.2 | 0.05 | 0.05 | 0.302 | Good | V. good | Good |
| Inv. Ex. 91 | | 75 | 7.2 | 0.05 | 0.15 | 0.312 | Good | V. good | Good |
| Inv. Ex. 92 | | 75 | 7.2 | 0.05 | 0.25 | 0.325 | V. good | V. good | V. good |
| Inv. Ex. 93 | | 75 | 8.5 | 0.12 | 0.04 | 0.293 | Fair | V. good | Fair |
| Inv. Ex. 94 | | 75 | 8.5 | 0.12 | 0.05 | 0.307 | Good | V. good | Good |
| Inv. Ex. 95 | | 75 | 8.5 | 0.12 | 0.15 | 0.320 | V. good | V. good | V. good |

1. A metal-clad laminate comprising
a base metal layer which is provided on a surface of a thermoplastic film; and
an upper metal layer which is provided on a surface of the base metal layer, wherein
the base metal layer is formed by a copper alloy which contains 0.05 to 0.21 mass % of phosphorus, and
the upper metal layer is formed by copper or a copper alloy.

2. The metal-clad laminate according to claim 1, wherein the thickness of the base metal layer is 0.05 μm to 0.25 μm.

3. The metal-clad laminate according to claim 1 or 2, wherein the film comprises of a thermoplastic film formable an optically anisotropic molten phase.

4. A method of producing a metal-clad laminate comprising:
providing a base metal layer comprised of a copper alloy on a surface of a thermoplastic film; and
providing an upper metal layer comprised of copper or a copper alloy on a surface of the base metal layer,
at treating an electroless copper plating for forming the base metal layer, dipping the laminate in an oxidizing agent after a catalyst activation process, and performing the electroless copper plating.

5. The method of producing a metal-clad laminate according to claim 4, wherein the upper metal layer is formed by electrolytic plating.
